(19) United States
(12) Patent Application Publication
(10) Pub. No.: US 2014/0321711 A1
(43) Pub. Date: Oct. 30, 2014

(54) VEHICLE ASSISTANCE DEVICE AND METHOD

(71) Applicant: HON HAI PRECISION INDUSTRY CO., LTD., New Taipei (TW)

(72) Inventors: HOU-HSIEN LEE, New Taipei (TW); CHANG-JUNG LEE, New Taipei (TW); CHIH-PING LO, New Taipei (TW)

(73) Assignee: HON HAI PRECISION INDUSTRY CO., LTD., New Taipei (TW)

(21) Appl. No.: 14/108,152

(22) Filed: Dec. 16, 2013

(30) Foreign Application Priority Data
Apr. 24, 2013 (TW) 102114567

(51) Int. Cl. B60Q 1/00; G06K 9/00

(52) U.S. Cl. CPC B60Q 1/00; G06K 9/00825
USPC 382/104

(57) ABSTRACT

An example vehicle assistance method includes obtaining a surroundings image captured by a camera. The method then creates a 3D surroundings model according to the surroundings image and the distances between each object recorded in the obtained surroundings image and the camera. Next, the method determines whether or not one or more second vehicles or passers-by appear in the created 3D surroundings model. If yes, the method then determines the shortest distance between the first vehicle and the second vehicle or passer-by, and determines whether or not the shortest distance between the first vehicle and the second vehicle or passer-by appearing in the created 3D surroundings model is less than a safe distance. If yes, the method drives a driving device to turn on a pair of lights.

### BACKGROUND

1. Related Applications

This application is related to U.S. patent application with an Attorney Docket Number of US49177 and a title of VEHICLE ASSISTANCE DEVICE AND METHOD, which has the same assignee as the current application and was concurrently filed.

2. Technical Field

The present disclosure relates to vehicle assistance devices, and particularly, to a vehicle assistance device capable of automatically turning on lights of a vehicle and a related method.

3. Description of Related Art

Usually, a driver determines to turn on lights of a vehicle according to visibility. The light emitted by the lights not only increases the visibility of the driver, but also helps others, such as the drivers of other vehicles or passers-by, to watch for the vehicle. Accordingly, there is a need for a vehicle assistance device capable of automatically turning on lights of a vehicle when the distance between the vehicle and other vehicles or passer-by is less than a safe distance.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a schematic diagram illustrating a vehicle assistance device connected with at least one camera, a driving device, and at least one lamp in accordance with an exemplary embodiment.

FIG. 2 is a schematic view showing the first vehicle.

FIG. 3 is a flowchart of a vehicle assistance method in accordance with an exemplary embodiment.

### DETAILED DESCRIPTION

The embodiments of the present disclosure are now described in detail, with reference to the accompanying drawings.

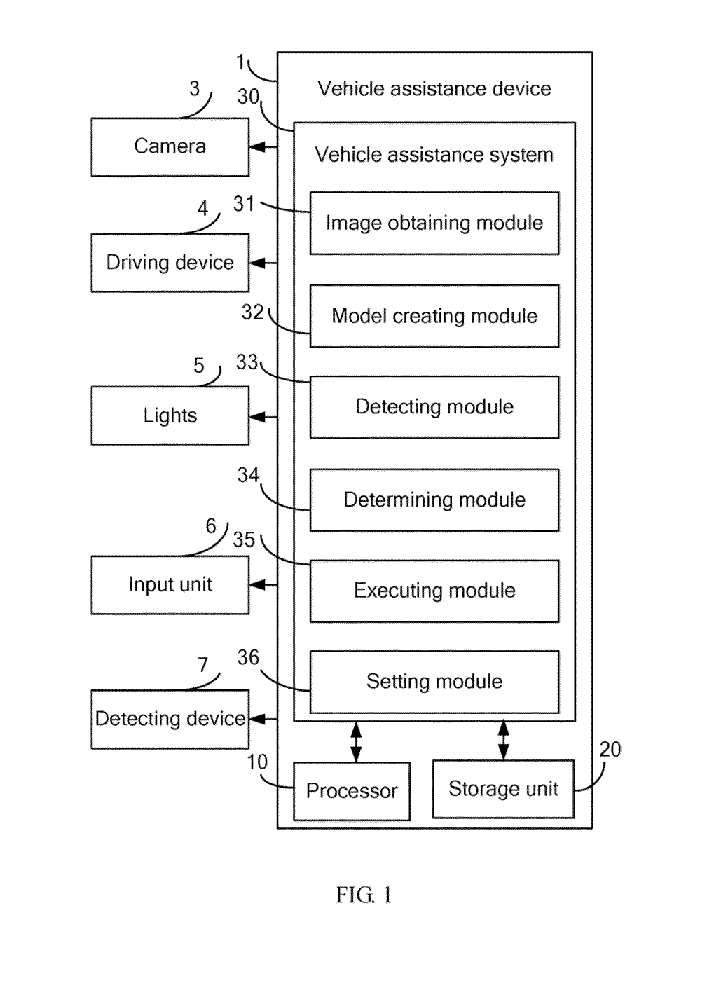

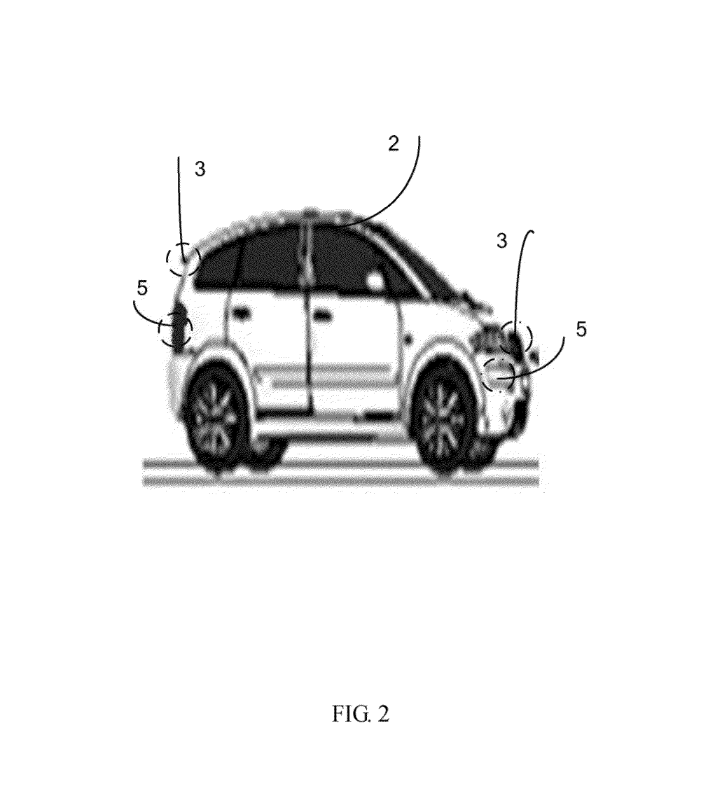

FIG. 1 is a schematic diagram illustrating a vehicle assistance device 1. The vehicle assistance device 1 is applied on a first vehicle 2 (see FIG. 2). The vehicle assistance device 1 is connected to at least one camera 3, a driving device 4, and at least one pair of lights 5. The vehicle assistance device 1 can analyze at least one surroundings image captured by the at least one camera 3, determine whether or not one or more second vehicles or passers-by appear in at least one surroundings image, and further control the driving device 4 to turn on the at least one pair of lights 5 when the distance between one second vehicle or one passerby appearing in at least one surrounding image and the first vehicle 2 is less than a safe distance, informing the driver of the one or more second vehicles or passers-by to watch for the first vehicle 2.

In the embodiment, the number of the cameras 3 is two. The cameras 3 are respectively arranged on the front and the rear of the first vehicle 2, respectively capture the surroundings in front of the vehicle and in rear of the vehicle to generate surroundings images. Each captured surroundings image includes distance information indicating the distance between one camera 3 and each object in the field of view of the camera 3. In the embodiment, the camera 3 is a Time of Flight (TOF) camera. In the embodiment, there are two pairs of lights 5 respectively arranged on the front and the rear of the first vehicle 2. The surroundings image captured by each camera 3 can be used to control the on of one pair of lights 5. For example, in FIG. 2, the surroundings image captured by the camera 3 circled by dotted line can be used to control the pair of lights 5 circled by dotted line to be turned on or off, in addition, the surroundings image captured by the camera 3 circled by broken line can be used to control the pair of lights circled by broken line to be turned on or off.

The vehicle assistance device 1 including a processor 10, a storage unit 20, and a vehicle assistance system 30. In the embodiment, the vehicle assistance system 30 includes an image obtaining module 31, a model creating module 32, a detecting module 33, a determining module 34, and an executing module 35. One or more programs of the above function modules may be stored in the storage unit 20 and executed by the processor 10. In general, the word “module”, as used herein, refers to logic embodied in hardware or firmware, or to a collection of software instructions, written in a programming language. The software instructions in the modules may be embedded in firmware, such as in an erasable programmable read-only memory (EPROM) device. The modules described herein may be implemented as either software and/or hardware modules and may be stored in any type of computer-readable medium or other storage device.

In the embodiment, the storage unit 20 further stores a number of 3D special vehicle models and a number of 3D special person models. Each 3D specific vehicle model has a unique name and includes a number of characteristic features. Each 3D special person model has one unique name and a number of characteristic features. The 3D specific vehicle models or the 3D special person models may be created based on a number of specific vehicle images or a number of specific person images pre-collected by the camera 3 and the distance between the camera 3 and the specific vehicle or the specific person recorded in the pre-collected specific vehicle images or the pre-collected specific person images.

The image obtaining module 31 obtains the surroundings image captured by each camera 3.

The model creating module 32 creates a 3D surroundings model corresponding to each camera 3 according to the obtained surroundings image captured by each camera 3 and the distance between the corresponding camera 3 and each object recorded in the obtained surroundings image.

The detecting module 33 determines whether or not one or more second vehicles or passers-by appear in at least one created 3D surroundings model. In detail, the detecting module 33 extracts object data corresponding to the shape of the one or more objects appearing in each created 3D surroundings model from each created 3D surroundings model. In addition, compares the extracted object data with characteristic feature of each of the 3D specific vehicle models and each of the 3D specific person models, to determine whether or not one or more second vehicles or passers-by appear in at least one created 3D surroundings model. If the extracted object data does not match the characteristic data of any of the 3D specific vehicle models and the 3D specific person models, the detecting module 33 determines that no second vehicle or passer-by appears in the created 3D surroundings models. If the extracted object data matches the characteristic data of one or more of the 3D specific vehicle models or the 3D specific person models, the detecting module 33 determines that one or more second vehicles or passers-by appear in the at least one created 3D surroundings model.

The determining module 34 determines the distance between the camera 3 and the second vehicle or passer-by appearing in each created 3D surroundings model as the distance between the first vehicle 2 and the second vehicle or passer-by appearing in each created 3D surroundings model. Then, determines the shortest distance between the first vehicle 2 and the second vehicle or passer-by appearing in each of the at least one created 3D surroundings model. In addition, determines whether or not the shortest distance between the first vehicle 2 and the second vehicle or passer-by appearing in the at least one created 3D surroundings model is less than the safe distance. In the embodiment, the safe distance is default or input by the driver through an input unit 6 connected to the vehicle assistance device 1. In detail, if the number of the second vehicle or passer-by appearing in the at least one created 3D surroundings model is one, the determining module 34 determines that the shortest distance between the first vehicle 2 and the second vehicle or passer-by is the distance between the first vehicle 2 and the second vehicle or passer-by. If the number of the second vehicle or passer-by appearing in the at least one created 3D surroundings model is more than one, the determining module 34 determines that the shortest distance between the first vehicle 2 and the second vehicle or passer-by is the shortest distance among the distances between the first vehicle 2 and the second vehicles or passers-by.

The executing module 35 determines the at least one created 3D surroundings model when the shortest distance between the first vehicle 2 and the second vehicle or the passer-by appearing in the at least one created 3D surroundings model is less than the safe distance. Then, determines the at least one camera 3 corresponding to the determined at least one created 3D surroundings model. In addition, controls the driving device 4 to turn on the at least one pair of lights 5 corresponding to the determined at least one camera 3, to inform the driver of the second vehicle or the passer-by to watch for the first vehicle 2.

In the embodiment, the vehicle assistance device 1 is further connected to a detecting device 7. The detecting device 7 detects the movement speed of the first vehicle 2. The storage unit 20 further stores a first table. The first table records a relationship between movement speed ranges of the first vehicle 2 and the safe distances. Each movement speed range of the first vehicle 2 corresponds to one safe distance.

First table

| Movement speed ranges of the first vehicle | Safe distance |
|---|---|
| 0-10 kilometers per hour | 15 meter |
| . . . | . . . |
| 40-50 kilometers per hour | 75 meter |

The vehicle assistance system 30 further includes a setting module 17. The setting module 17 obtains the movement speed of the first vehicle 2 detected by the detecting device 7. Then, determines the movement speed range of the first vehicle 2 that the movement speed of the first vehicle 2 is in. In addition, determines the safe distance corresponding to the movement speed range of the first vehicle 2 according to the relationship between movement speed ranges of the first vehicle 2 and the safe distances.

In other embodiments, the storage unit 20 further stores a second table. The second table records a relationship between the movement speed range of the first vehicle 2, the driving levels of the driver, and the safe distances. Each movement speed range of the first vehicle 2 corresponds to a number of driving levels of the driver and a number of safe distances. Each movement speed range of the first vehicle 2 and each driving level of the driver correspond to one safe distance. In the embodiment, the driving level of the driver is preset by the driver through the input unit 6.

Second table

| Movement speed ranges | driving levels | Safe |
|---|---|---|
| of the first vehicle | of the driver | distances |
| 0-10 kilometers per hour | new | 35 meter |
| | common | 25 meter |
| | experienced | 15 meter |
| . . . | . . . | . . . |
| | . . . | . . . |
| | . . . | . . . |
| 40-50 kilometers per hour | new | 95 meter |
| | common | 85 meter |
| | experienced | 75 meter |

The setting module 17 obtains the movement speed of the first vehicle 2 detected by the detecting device 7. Then, determines the movement speed range of the first vehicle 2 that the first vehicle 2 is in according to the movement speed of the first vehicle 2. In addition, obtains the preset driving level of the driver, and determines the safe distance corresponding to the movement speed range of the first vehicle 2 and the preset driving level of the driver according to the relationship between movement speed ranges of the first vehicle 2, the driving levels of the driver, and the safe distances.

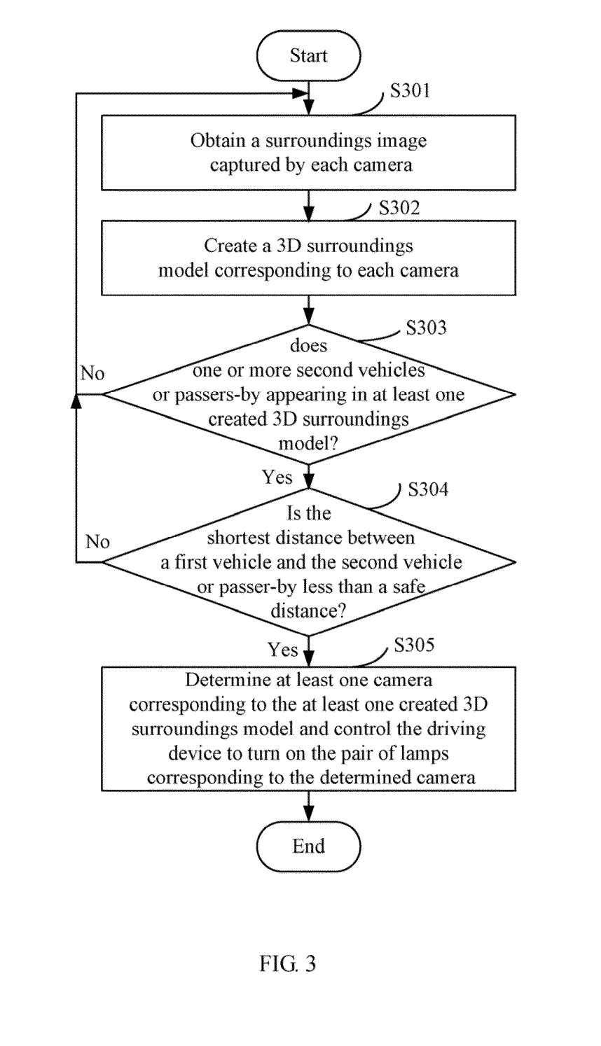

FIG. 3 shows a vehicle assistance method in accordance with an exemplary embodiment.

In step S301, the image obtaining module 31 obtains a surroundings image captured by each camera 3.

In step S302, the model creating module 32 creates a 3D surroundings model corresponding to each camera 3 according to the surroundings image captured by each camera 3 and the distances between each object recorded in the obtained surroundings image and the corresponding camera 3.

In step S303, the detecting module 33 determines whether or not one or more second vehicles or passers-by appear in at least one created 3D surroundings model. If one or more second vehicles or passers-by appear in the at least one 3D surroundings model, the procedure goes to step S304. If no second vehicle and passer-by appearing in the created 3D surrounding models, the procedure goes to step S301. In detail, the detecting module 33 extracts object data corresponding to the shape of the one or more objects appearing in each created 3D surroundings model from each created 3D surroundings model. Then, compares the extracted object data with characteristic feature of each of the 3D specific vehicle models and each of the 3D specific person models, to determine whether or not one or more second vehicles or passers-by appear in at least one created 3D surroundings model. If the extracted object data does not match the characteristic data of any of the 3D specific vehicle models and the 3D specific person models, the detecting module 33 determines that no second vehicle or passer-by appears in the created 3D surroundings models. If the extracted object data matches the characteristic data of one or more of the 3D specific vehicle models or the 3D specific person models, the detecting module 33 determines that one or more second vehicles or passers-by appear in at least one created 3D surroundings model.

In step S304, the determining module 34 determines the distance between the camera 3 and the second vehicle or passer-by appearing in each created 3D surroundings model as the distance between the first vehicle 2 and the second vehicle or passer-by appearing in each created 3D surroundings model. Then, determines the shortest distance between the first vehicle 2 and the second vehicle or passer-by appearing in each of the at least one created 3D surroundings model. In addition, determines whether or not the shortest distance between the first vehicle 2 and the second vehicle or passer-by appearing in the at least one created 3D surroundings model is less than the safe distance. If the shortest distance between the first vehicle 2 and the second vehicle or passer-by appearing in the at least one created 3D surroundings model is less than the safe distance, the procedure goes to step S305. If the shortest distance between the first vehicle 2 and the second vehicle or passer-by appearing in each created 3D surroundings model is more than the safe distance, the procedure goes to step S301.

In step S305, the executing module 35 determines the at least one created 3D surroundings model when the shortest distance between the first vehicle 2 and the second vehicle or the passer-by appearing in the at least one created 3D surroundings model is less than the safe distance, determines the at least one camera 3 corresponding to the determined at least one created 3D surroundings model, and controls the driving device 4 to turn on at least one pair of lights 5 corresponding to the determined at least one camera 3, to inform the driver of the second vehicle or the passer-by to watch for the first vehicle 2.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A vehicle assistance device applied on a first vehicle comprising:
a storage system;
a processor;
one or more programs stored in the storage system, executable by the processor, the one or more programs comprising:
an image obtaining module operable to obtain a surroundings image captured by at least one camera, each of the at least one image comprising a distance information indicating distances between the corresponding camera and each object captured by the corresponding camera;
a model creating module operable to create a 3D surroundings model corresponding to each camera according to the surroundings image captured by each camera and the distances between each object recorded in the obtained surroundings image and the corresponding camera;
a detecting module operable to determine whether or not one or more second vehicles or passers-by appear in at least one created 3D surroundings model;
a determining module operable to determine the distance between the camera and the second vehicle or passer-by appearing in each of the at least one created 3D surroundings model as the distance between the first vehicle and the second vehicle or passer-by appearing in each created 3D surroundings model, determine the shortest distance between the first vehicle and the second vehicle or passer-by appearing in each of the at least one created 3D surroundings model, and determine whether or not the shortest distance between the first vehicle and the second vehicle or passer-by appearing in the at least one created 3D surroundings model is less than a safe distance; and
an executing module operable to determine the at least one created 3D surroundings model when the shortest distance between the first vehicle and the second vehicle or passer-by appearing in the at least one created 3D surroundings model is less than the safe distance, determine at least one camera corresponding to the at least one created 3D surroundings model, and control a driving device to turn on at least one pair of lights corresponding to the determined at least one camera.

2. The vehicle assistance device as described in claim 1, wherein the vehicle assistance system further comprises a setting module, the setting module is operable by the processor to obtain a movement speed of the first vehicle detected by a detecting device, determine a movement speed range of the first vehicle that the movement speed of the first vehicle is in, and determine the safe distance corresponding to a movement speed range of the first vehicle according to a stored relationship between movement speed ranges of the first vehicle and the safe distances.

3. The vehicle assistance device as described in claim 1, wherein the vehicle assistance system further comprises a setting module, the setting module is operable to obtain a movement speed of the first vehicle detected by a detecting device, determine a movement speed range of the first vehicle that the movement speed of the first vehicle is in, obtain a preset driving level of a driver, and determine the safe distance corresponding to the determined movement speed range of the first vehicle and the obtained preset driving level of the driver according to a stored relationship between movement speed ranges of the first vehicle, the driving level of the driver, and the safe distances.

4. The vehicle assistance device as described in claim 3, wherein the detecting module is further operable to extract object data corresponding to the shape of the one or more objects appearing in each created 3D surroundings model from each created 3D surroundings model, and compare the extracted object data with characteristic feature of each of the 3D specific vehicle models and each of the 3D specific person models, to determine whether or not one or more second vehicles or passers-by appear in at least one created 3D surroundings model; if the extracted object data does not match the characteristic data of any of the 3D specific vehicle models and the 3D specific person models, the detecting module determines that no second vehicle or passer-by appears in the created 3D surroundings models; if the extracted object data matches the characteristic data of one or more of the 3D specific vehicle models or the 3D specific person models, the detecting module determines that one or more second vehicles or passers-by appear in the at least one created 3D surroundings model.

5. A vehicle assistance method comprising:
obtaining a surroundings image captured by at least one camera, each of the at least one image comprising a distance information indicating distances between the corresponding camera and each object captured by the corresponding camera;
creating a 3D surroundings model corresponding to each camera according to the surroundings image captured by each camera and the distances between each object recorded in the obtained surroundings image and the corresponding camera;
determining whether or not one or more second vehicles or passers-by appear in at least one created 3D surroundings model;
determining the distance between the camera and the second vehicle or passer-by appearing in each of the at least one created 3D surroundings model as the distance between the first vehicle and the second vehicle or passer-by appearing in each created 3D surroundings model, determining the shortest distance between the first vehicle and the second vehicle or passer-by appearing in each of the at least one created 3D surroundings model, and determining whether or not the shortest distance between the first vehicle and the second vehicle or passer-by appearing in the at least one created 3D surroundings model is less than a safe distance; and
determining at least one created 3D surroundings model when the shortest distance between the first vehicle and the second vehicle or passer-by appearing in the at least one created 3D surroundings model is less than the safe distance, determining at least one camera corresponding to the at least one created 3D surroundings model, and controlling a driving device to turn on at least one pair of lights corresponding to the determined at least one camera.

6. The vehicle assistance method as described in claim 5, wherein the method further comprises:
obtaining a movement speed of the first vehicle detected by a detecting device, determining a movement speed range of the first vehicle that the movement speed of the first vehicle is in, and determining the safe distance corresponding to a movement speed range of the first vehicle according to a stored relationship between movement speed ranges of the first vehicle and the safe distances.

7. The vehicle assistance method as described in claim 5, wherein the method further comprises:
obtaining a movement speed of the first vehicle detected by a detecting device, determining a movement speed range of the first vehicle that the movement speed of the first vehicle is in, obtaining a preset driving level of a driver, and determining the safe distance corresponding to the determined movement speed range of the first vehicle and the obtained preset driving level of the driver according to a stored relationship between movement speed ranges of the first vehicle, the driving level of the driver, and the safe distances.

8. The vehicle assistance method as described in claim 5, wherein the method further comprises:
extracting object data corresponding to the shape of the one or more objects appearing in each created 3D surroundings model from each created 3D surroundings model, and comparing the extracted object data with characteristic feature of each of the 3D specific vehicle models and each of the 3D specific person models, to determine whether or not one or more second vehicles or passers-by appear in at least one created 3D surroundings model;
determining that no second vehicle or passer-by appears in the created 3D surroundings models if the extracted object data does not match the characteristic data of any of the 3D specific vehicle models and the 3D specific person models; and
determining that one or more second vehicles or passers-by appear in the at least one created 3D surroundings model if the extracted object data matches the characteristic data of one or more of the 3D specific vehicle models or the 3D specific person models.

9. A storage medium storing a set of instructions, the set of instructions capable of being executed by a processor of a vehicle assistance device, cause the vehicle assistance device to perform a vehicle assistance method, the method comprising:
obtaining a surroundings image captured by at least one camera, each of the at least one image comprising a distance information indicating distances between the corresponding camera and each object captured by the corresponding camera;
creating a 3D surroundings model corresponding to each camera according to the surroundings image captured by each camera and the distances between each object recorded in the obtained surroundings image and the corresponding camera;
determining whether or not one or more second vehicles or passers-by appear in at least one created 3D surroundings model;
determining the distance between the camera and the second vehicle or passer-by appearing in each of the at least one created 3D surroundings model as the distance between the first vehicle and the second vehicle or passer-by appearing in each created 3D surroundings model, determining the shortest distance between the first vehicle and the second vehicle or passer-by appearing in each of the at least one created 3D surroundings model, and determining whether or not the shortest distance between the first vehicle and the second vehicle or passer-by appearing in the at least one created 3D surroundings model is less than a safe distance; and
determining at least one created 3D surroundings model when the shortest distance between the first vehicle and the second vehicle or passer-by appearing in the at least one created 3D surroundings model is less than the safe distance, determining at least one camera corresponding to the at least one created 3D surroundings model, and controlling a driving device to turn on at least one pair of lights corresponding to the determined at least one camera.

10. The storage medium as described in claim 9, wherein the method further comprises:
obtaining a movement speed of the first vehicle detected by a detecting device, determining a movement speed range of the first vehicle that the movement speed of the first vehicle is in, and determining the safe distance corresponding to a movement speed range of the first vehicle according to a stored relationship between movement speed ranges of the first vehicle and the safe distances.

11. The storage medium as described in claim 9, wherein the method further comprises:
obtaining a movement speed of the first vehicle detected by a detecting device, determining a movement speed range of the first vehicle that the movement speed of the first vehicle is in, obtaining a preset driving level of a driver, and determining the safe distance corresponding to the determined movement speed range of the first vehicle and the obtained preset driving level of the driver according to a stored relationship between movement speed ranges of the first vehicle, the driving level of the driver, and the safe distances.

12. The storage medium as described in claim 9, wherein the method further comprises:
extracting object data corresponding to the shape of the one or more objects appearing in each created 3D surroundings model from each created 3D surroundings model, and comparing the extracted object data with characteristic feature of each of the 3D specific vehicle models and each of the 3D specific person models, to determine whether or not one or more second vehicles or passers-by appear in at least one created 3D surroundings model;
determining that no second vehicle or passer-by appears in the created 3D surroundings models if the extracted object data does not match the characteristic data of any of the 3D specific vehicle models and the 3D specific person models; and
determining that one or more second vehicles or passers-by appear in the at least one created 3D surroundings model if the extracted object data matches the characteristic data of one or more of the 3D specific vehicle models or the 3D specific person models.
